(19) United States
(12) Patent Application Publication
(10) Pub. No.: US 2006/0217451 A1
(43) Pub. Date: Sep. 28, 2006

(54) Polyurethane or polyisocyanurate foam composition

(76) Inventor: Vittorio Bonapersona, Ferney Voltaire (FR)

Correspondence Address: GEAM - SILICONES - 60SI;IP LEGAL, ONE PLASTICS AVENUE, PITTSFIELD, MA, 01201-3697, US

(21) Appl. No.: 11/091,945

(22) Filed: Mar. 28, 2005

(51) Int. Cl. C08G 18/48

(52) U.S. Cl. 521/131

(57) ABSTRACT

Polyurethane or polyisocyanurate foam composition wherein at least 10 percent of the blowing gas volume is carbon dioxide formed from the reaction of polyisocyanate and water or organic acid and including a dipolar aprotic solvent in an amount from 1 percent by weight to 10 percent by weight based on the total weight of the foam forming mixture.

### BACKGROUND OF THE INVENTION

Polyurethane and polyisocyanurate foams made in presence of a higher than usual amount of chemically generated carbon dioxide or using the sole chemically generated gas as a blowing agent tend to be very brittle at the surface making it very difficult to obtain good adhesion to a substrate. This friability can be reduced by the use of a certain catalyst or by using longer chain polyols or by heating the substrate but in all cases this represents a significant limitation or change in technology.

The introduction of certain organic polar solvents into polyisocyanurate foam forming mixtures, for example as a part of the catalyst component, has been described hitherto but the amounts so introduced have been significantly less than the amounts required in the present content; see for example, U.S. Pat. Nos. 3,625,872; 3,746,709; 3,849,349; 3,896,052; 3,903,018; 4,033,908 and 4,071,482.

The use of certain aprotic solvents is mentioned in U.S. Pat. No. 4,071,482, which relates to Highly flame-resistant polyurethane foams of improved friability and reduced brittleness without a corresponding substantial increase in flame-spread or smoke-generation characteristics are prepared by incorporating into a foamable polyurethane composition an amount of a liquid organic carbonate, such as ethylene or propylene carbonate, and U.S. Pat. No. 4,335,228, which relates to improve adhesion between the skin and core of laminates having rigid polyisocyanurate foam cores by incorporating a dipolar aprotic organic solvent, in a minor amount, into the reaction mixture employed to prepare the polyisocyanurate foam core.

However, although the prior art may disclose the use of water as a chemically active blowing agent, the prior art does not address the problem of lack of adhesion and increased friability of either polyurethane or polyisocyanurate foams caused by the use of a water-isocyanate reaction as a chemical blowing agent. More specifically, the prior art references above fail to disclose or suggest the use of water in such an amount that would provide carbon dioxide in an amount of at least 10 percent of the total blowing gas volume and including a dipolar aprotic solvent in an amount from about 1 percent by weight to about 10 percent by weight based on total weight of the foam forming mixture.

### BRIEF DESCRIPTION OF THE INVENTION

In accordance with an exemplary embodiment of the present invention, a polyurethane or polyisocyanurate foam composition is provided where at least 10 percent of the blowing gas volume is carbon dioxide formed from the reaction of a polyisocyanate and water or an organic acid and includes a dipolar aprotic solvent in an amount from about 1 percent by weight to about 10 percent by weight based on total weight of the foam forming mixture.

Advantages of the foams produced in accordance with the exemplary embodiments of the present invention exhibit improved cure and reduced friability. In addition, the reduction of friability of the foams, especially at their surface, that is achieved in accordance with the present invention results in improved adhesion of the foams and their substrates and/or less need for heating the substrates to provide an improved level of adhesion.

The term “dipolar aprotic organic solvent” is used throughout this specification and claims in its conventionally accepted sense, namely, as designating a solvent which cannot donate a suitably labile hydrogen atom or atoms to form strong hydrogen bonds with an appropriate species (or to react with a polyisocyanate); see, for example, Parker, Quarterly Reviews XVI, 163, 1962. Illustrative of dipolar organic solvents are dialkyl sulfoxides such as dimethyl sulfoxide, diethyl sulfoxide, diisobutyl sulfoxide, and the like; N,N-dialkylalkanoamides such as N,N-dimethylformamide, N,N-dimethylacetamide, N,N-diethylacetamide and the like; phosphonates such as O,O-dimethyl, O,O-diethyl, O,O-diisopropyl methylphosphonates, O,O-di(2-chloroethyl) vinylphosphonate, and the like; tetramethylenesulfone, 1-methyl-2-pyrrolidinone, trialkyl phosphates such as trimethyl and triethyl phosphates, acetonitrile, and the like, organic carbonates like di-methyl-carbonate, ethylene-carbonate, propylene-carbonate, esters of mono or poly-hydroxyl alchools and the like.

The term “friability” refers to the state of the surface of the polyurethane foam; that is, the powderability of the surface when subject to pressure, which friability changes with time, while “brittleness” is used throughout this specification and claims in its conventionally accepted sense, namely refers to the internal friability of the foam structure which remains essentially unchanged with time; that is, it is structural and molecular in nature.

### DETAILED DESCRIPTION OF THE INVENTION

A polyurethane or polyisocyanurate foam composition where at least 10 percent of a blowing gas volume is carbon dioxide formed by reacting a polyisocyanate and water or an organic acid and further comprises a dipolar aprotic solvent in an amount from about 1 percent by weight to about 10 percent by weight based on total weight of the foam forming mixture.

According to an embodiment of the present invention, incorporating dipolar aprotic solvents in either a polyurethane or polyisocyanurate foam forming reaction mixture having an unusual amount of water present, it is possible to significantly reduce surface friability and obtain excellent adhesion of a foam core to facer skin without the necessity of high curing temperatures. It has also been observed that the friability of the polyisocyanurate or polyurethane in the layer immediately abutting the skin facers is significantly less than is the case where a polymer foam reaction mixture, identical in composition except for the absence of the dipolar aprotic solvent, has been used.

In the case of polyisocyanurate foams, the use of the solvent of the present invention also contributes to reducing the formation of wrinkles on a surface of the polyisocyanurate foam, which indicates a sufficient degree of crosslinking is present in the formulations in accordance with the exemplary embodiments of the present invention.

The known methods for production of laminates include production of individual sandwich panels as well as continuous foam laminate board production. In the former process, the foam forming reaction mixture is dispensed, generally using appropriate mechanical mixing and dispensing means, between two facer sheets which have been pre-assembled in an appropriate mold. The dispensing of the foam mixture can be accomplished by pouring or spraying in accordance with well-known techniques.

In the continuous method, the polymer foam forming reaction mixture is dispensed onto a lower facing sheet which is flexible and is being continuously drawn from a supply roll and advanced on a supporting belt. Downstream from the point at which the foam forming mixture is deposited onto the lower facing sheet, a second facing sheet, dispensed from a continuous roll in the case of flexible facer material such as aluminum sheet, asphalt-saturated felt, kraft paper, and the like or dispensed in the form of individual plates in the case of a rigid facer such as sheet steel, gypsum board wood panels and the like is brought into contact with the upper surface of the rising foam. In general, the second facer sheet is brought into contact with the foam at the stage at which the foam forming reaction has progressed to such an extent that the foam has acquired sufficient strength to support the weight of the second facer sheet. After the completion of this step, the laminate is then passed through a shaping device to control thickness and finally through a curing zone in which the foam-cored laminate is subjected to temperatures of the order of about 200° F. The heat curing step is generally required in order to ensure adequate bonding of the foam core to the abutting surfaces of the facer sheets in addition to effecting cure of the foam core itself.

Similarly, in the case of the foam core panels which are formed by the pour-in-place method in individual molds as described above, the panels are subjected to a heat curing process, involving the use of temperatures of the order of about 180° F. in order to ensure adequate bonding of the foam core to the abutting surfaces of the facer sheets as well as completion of the cure of the foam core itself.

The polymer foam forming reaction mixtures employed in the preparation of polyisocyanurate foam-cored laminates in accordance with the procedures outlined above comprise a polyisocyanate, a minor amount (usually less than about 0.5 equivalents per equivalent of polyisocyanate) of a polyol, a trimerizing catalyst (i.e. a catalyst for trimerizing an isocyanate to form isocyanurate linkages) and a blowing agent. The various components are brought together and mixed using manual or mechanical mixing means to form the foam reaction mixture. Generally, the polyol and catalyst are preblended to form a single component which is fed as one stream to a conventional mixing head and admixed with the polyisocyanate which is fed as a separate stream to the mixing head. A blowing agent can be fed as a separate stream to the mixing head or blended with one or other, or both, of the other components prior to feeding the latter to the mixing head. According to an embodiment of the present invention, the blowing agent is carbon dioxide. According to another embodiment of the present invention, at least 30 percent of a blowing gas volume is carbon dioxide formed by reacting a polyisocyanate and water or an organic acid. According to another embodiment, the blowing agent includes a physical blowing agent that comprises no more than 70 percent of the total blowing gas volume. According to another embodiment of the present invention, the physical blowing agent is a volatile solvent such as acetone, ethyl acetate, halogenated alkanes such as methylene chloride, chloroform, ethylidene chloride, vinylidene chloride, monofluorotrichloromethane, chlorodifluoromethane, dichlorodifluoromethane, trichlorofluoromethane, trichlorotrifluoroethane, hydrochlorofluorocarbon compound, a hydrofluorocarbon compound, butane, hexane, heptane, diethylether, pentane, and the like. According to another embodiment of the present invention, the physical blowing is a pentane such as n-pentane, isopentane, cyclopentane, or mixtures thereof. According to another embodiment of the present invention, the physical blowing agent is pentafluorobutane, pentafluoropropane or tetrafluoroethane. According to yet another embodiment, compounds which decompose at temperatures above room temperature to liberate gases, for example nitrogen, may also act as blowing agents, e.g. azo compounds such as azoisobutyric acid nitrile. Other examples of blowing agents and details about the use of blowing agents may be found in Kunststoff-Handbuch, Volume VII, published by Vieweg and Hochtlen, Carl-Hanser-Verlag, Munich 1966, e.g. on pages 108 and 109, 453 to 455 and 507 to 510, the disclosure of which is incorporated herein by reference.

According to another embodiment of the present invention, at least 30 percent of the blowing gas volume is carbon dioxide formed from the reaction of polyisocyanate and water or organic acid. In addition, a physical blowing agent may be included that comprises 70 percent or less of the total blowing gas volume.

According to another embodiment of the present invention, at least 50 percent of the blowing gas volume is carbon dioxide formed from the reaction of polyisocyanate and water or organic acid. In addition, a physical blowing agent may be included that comprises 50 percent or less of the total blowing gas volume.

According to another embodiment of the present invention, at least 70 percent of the blowing gas volume is carbon dioxide formed from a reaction of polyisocyanate and water or organic acid. In addition, a physical blowing agent may be included that comprises 30 percent or less of the total blowing gas volume

According to another embodiment of the present invention, an appropriate quantity, e.g., from about 1 percent by weight to about 10 percent by weight based on the total weight of the foam forming mixture, of the dipolar aprotic solvent is added to the polyisocyanate or to the polyol component or, if desired, split between each of these two components of the foam-forming reaction mixture. Having included the solvent in the foam reaction mixture in this manner, the production of the laminate can then proceed using any of the methods known in the art without the necessity to modify or change any of the conventionally used procedures.

It has been found that, by so incorporating the dipolar aprotic solvents in the foam forming reaction mixtures where at least 10 percent of the blowing gas volume is carbon dioxide formed by the reaction of polyisocyanate and water or organic acid, it is possible to obtain excellent adhesion of a foam core to facer skin without the necessity to use curing temperatures of the above-mentioned order. This holds true for a wide range of thicknesses of the foam core from as little as about 0.5 inches to as high as 4 inches or greater. Thus, it has been found that curing temperatures as low as about 100° F. are entirely adequate for obtaining good adhesion when employing the improvement of the present invention. It has also been observed that the friability of the polyisocyanurate foam core in the layer immediately abutting the skin facers is significantly less than is the case where a polymer foam reaction mixture, identical in composition except for the absence of the dipolar aprotic solvent, has been used.

Any of the polyisocyanates conventionally employed in the art of preparing polyisocyanurate foams can be employed in the foam reaction mixtures discussed above. According to another embodiment of the present invention, polyisocyanates known as polymethylene polyphenyl polyisocyanates can be employed in the foam reaction mixtures discussed above. According to another embodiment of the present invention, polymethylene polyphenyl polyisocyanates comprise from about 20 to about 85 percent by weight of methylenebis(phenyl isocyanate) the remainder of the mixture being polymethylene polyphenyl polyisocyanates of functionality greater than 2.0. A detailed description of these polyisocyanates and methods for their preparation is found in U.S. Pat. No. 3,745,133.

According to another embodiment of the present invention, any organic polyisocyanate may be used in the process of the present invention. Suitable polyisocyanates include aromatic, aliphatic, araliphatic and cycloaliphatic polyisocyanates and combinations thereof. Examples of useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, hexahydrotoluene diisocyanate and its isomers, 1,5-naphthylene diisocyanate, 1-methyl-phenyl-2,4-phenyl diisocyanate, 4,4′-diphenyl-methane diisocyanate, 2,4′-diphenyl-methane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and polyisocyanates such as 4,4′-dimethyl-diphenyl-methane-2,2′, 5,5′-tetraisocyanate and the polymethylene polyphenylpolyisocyanates. According to another embodiment of the present invention, the polyisocyanate is polymethylene polyphenyl polyisocyanate, meta or para pheylene diisocyanate, hexamethylene diisocyanate, toluene diisocyanate and diphenylmethane diisocyanate.

Similarly, any of the polyols conventionally employed in the production of polyisocyanurate foams can be employed in the foam reaction mixture employed in preparing laminates in accordance with this invention. Such polyols include polyether and polyester polyols having functionalities from 2 to 6 and molecular weights ranging from about 60 up to about 1000 or higher. While polyols having higher molecular weights can be employed, the polyols tend to be solids or highly viscous liquids and are accordingly less desirable because of handling and miscibility considerations.

The polyols are generally employed in the foam forming reaction mixture in amounts in the range of about 0.01 equivalents to about 0.4 equivalents per equivalent of polyisocyanate. A detailed description and exemplification of such polyols is given in the aforesaid U.S. Pat. No. 3,745,133.

The trimerization catalysts, and the proportions thereof, which are employed in the polymer foam reaction mixtures utilized in accordance with the embodiments of the present invention can be any of those known in the art; see, for example, the aforesaid U.S. Pat. No. 3,745,133 as well as U.S. Pat. Nos. 3,896,052; 3,899,443 and 3,903,018.

The process of the invention can be applied to the preparation of laminates using any of the types of facer material (such as those exemplified above) and the advantages of improved adhesion will be manifested. However, the problem of poor adhesion is particularly acute in the case of the various metal facers and it is with metallic facers that the process of the invention finds particular application.

The laminates produced in accordance with the process of the invention can be used for all purposes for which such laminates are conventionally used. Illustratively, the laminates can be employed as thermal barriers and insulation materials in roof decks and as wall insulation in all types of construction in industrial buildings, cold storage areas and the like.

According to another embodiment of the present invention, a polyurethane or polyisocyanurate foam composition may further comprise optional known additives such as activators, catalysts or accelerants, colorants, pigments, dyes, crosslinking/chain-extending agents, surfactants, fillers, stabilizers, antioxidants, plasticizers, flame retardants and the like.

For example, fillers may include conventional organic and inorganic fillers and reinforcing agents. More specific examples include inorganic fillers, such as silicate minerals, for example, phyllosilicates such as antigorite, serpentine, hornblends, amphiboles, chrysotile, and talc; metal oxides, such as aluminum oxides, titanium oxides and iron oxides; metal salts, such as chalk, barite and inorganic pigments, such as cadmium sulfide, zinc sulfide and glass, inter alia; kaolin (china clay), aluminum silicate and co-precipitates of barium sulfate and aluminum silicate, and natural and synthetic fibrous minerals, such as wollastonite, metal, and glass fibers of various lengths. Examples of suitable organic fillers are carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and in particular, carbon fibers. According to another embodiment of the present invention, the inorganic and organic fillers may be used individually or as mixtures.

Examples of suitable flame retardants are tricresyl phosphate, tris(2-chloroethyl) phosphate, tris(2-chloropropyl) phosphate, and tris(2,3-dibromopropyl) phosphate. A suitable flame retardant in compositions of the present invention comprises FYROL PCF®, which is a tris(chloro propyl)phosphate, from Akzo Nobel Functional Chemicals.

In addition to the above-mentioned halogen-substituted phosphates, it is also possible to use inorganic or organic flame retardants, such as red phosphorus, aluminum oxide hydrate, antimony trioxide, arsenic oxide, ammonium polyphosphate (EXOLIT® from Clariant) and calcium sulfate, expandable graphite or cyanuric acid derivatives, e.g., melamine, or mixtures of two or more flame retardants, e.g., ammonium polyphosphates and melamine, and, if desired, corn starch, or ammonium polyphosphate, melamine, and expandable graphite and/or, if desired, aromatic polyesters.

According to another embodiment of the present invention, UV performance enhancers, or UV light stabilizers, may be included in the form reaction mixtures to prevent the breakdown and loss of chemical and physical properties in the composite structure due to UV light. According to another embodiment of the present invention, the UV performance enhancers include Tinuvin® 1130 and Tinuvin® 292 from Ciba. Of course, any other UV performance enhancers available from Ciba or any other equivalent suppliers may be included. In addition, other UV performance enhancers may include, but are not limited to, Tinuvin® 123 and Tinuvin® 900 from Ciba.

Further details on the other conventional assistants and additives mentioned above can be obtained from the specialist literature, for example, from the monograph by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983; incorporated herein by reference.

The following examples described the manner and process of making and using the invention and set forth the best mode contemplated by the inventor of carrying out the invention but is not to be construed as limiting.

### EXAMPLE 1

A series of model rigid-faced sandwich panels with polyurethane foam cores was prepared using the following standard procedure.

A galvanized steel plate (30 cm×30 cm×6 cm) adjusted to the desired temperature was placed in the bottom of a metal mold of the same size. The top of the mold was then sealed with a similar steel plate. A sufficient amount of a polyurethane foam-forming mixture (prepared by combining the components and amounts thereof shown in Table 1) was introduced into the mold so that the risen foam would entirely fill the mold cavity and reach the desired density. The mold was then placed in an oven. The foam was allowed to remain in the oven for about 5 minutes at the temperature of the mold indicated in Table 1. The cured foam sandwich panel thus obtained was then removed from the oven and left to condition in a vertical position at room temperature for about 24 hours. Specimens were cut in order to qualitatively test the strength of the bond between the steel plates and the foam core.

In the case of a control panel made with Foam Composition A (no solvent used; see Table I), there was relatively weak adhesion between the steel plates and the polyurethane core at a mold temperature of 35° C. However, when the mold temperature was held at a temperature of 45° C., there was a significant increase in the adhesion between the steel plates and the polyurethane core.

In the case of panels made with Foam Composition B (with ethylene carbonate used as a solvent), there was good adhesion between the steel plates and the polyurethane core at 35° C. Further, at 45° C., the foam to steel adhesion was even stronger. The adhesion between the steel plates and the foam core processed at 45° C. was stronger than the epoxy glue used to fix the specimen to the dynamometer clamps.

In addition, about 10 minutes after the completion of the foam reaction and at room temperature, it was observed that Foam Composition A showed a higher surface friability than Foam Composition B which showed no surface friability.

TABLE 1

| | Parts By Weight | |
|---|---|---|
| Foam Composition | A | B |
| Daltolac ® R 180 (Sucrose-Based Polyol | 80.0 | 80.0 |
| available from Huntsman, LLC.) | | |
| TCPP (tris(2-chloropropyl phosphate)) | 20.0 | 20.0 |
| Niax ® catalyst DMBA (dimethylbenzylamine | 2.2 | 2.2 |
| catalyst available from GE silicones) | | |
| Niax ® catalyst A1 | 0.2 | 0.2 |
| (bis(dimethylaminoethyl)ether catalyst | | |
| available from GE Silicones) | | |
| Water | 4.0 | 4.0 |
| Niax ® Silicone SR 321 (available from GE | 2.0 | 2.0 |
| Silicones) | | |
| Ethylene Carbonate | | 4.0 |
| Suprasec DNR (polymeric MDI available | 155 | 155 |
| from Imperial Chemical Industries) | | |
| Surface friability at Ambient Temperature | YES | NO |
| Mold Temperature, ° C. | 35 | 35 |
| Adhesion, KPa | 82.8 | 174.4 |
| Mold Temperature, ° C. | 45 | 45 |
| Adhesion, KPa | 196.6 | >240 (broken |
| | | epoxy glue) |

### EXAMPLE 2

A fully water blown polyisocyanurate (PIR) formulation, described in Table 2 as Foam Composition C, was introduced onto foil paper placed on a metal mold heated at 55° C. Foam Compositions D and E were prepared in a similar manner as Foam Composition C except Foam Compositions D and E further included solvents Ethylene Carbonate and Dimethylsulfoxide (DMSO), respectively. It was observed that Foam Compositions D and E showed no friability and improved adhesion between the foil paper and the polyisocyanurate core. Whereas, the polyisocyanurate core prepared using Foam Composition C showed surface friability and the foil paper completely peeled from the polyisocyanurate foam core after 10 minutes.

TABLE 2

| | Parts By Weight | | |
|---|---|---|---|
| Foam Composition | C | D | E |
| TERATE 2541 (a polyol available from | 22.6 | 22.6 | 22.6 |
| Invista) | | | |
| Water | 1.0 | 1.0 | 1.0 |
| Niax ® Potassium Octoate (72% solution, | 0.5 | 0.5 | 0.5 |
| available from GE Silicones) | | | |
| TCPP (tris(2-chloropropyl phosphate) | 6.87 | 6.87 | 6.87 |
| Niax ® Potassium Acetate (40% solution, | 0.50 | 0.50 | 0.50 |
| available from GE Silicones) | | | |
| Niax ® Silicone L-5107(available from | 0.70 | 0.70 | 0.70 |
| GE Silicones) | | | |
| DMBA(dimethylbenzylamine catalyst | 0.50 | 0.50 | 0.50 |
| available from Protex) | | | |
| Niax ® catalyst A-1 | 0.05 | 0.05 | 0.05 |
| (bis(dimethylaminoethyl)ether catalyst | | | |
| available from GE Silicones) | | | |
| Ethylene Carbonate | | 1.00 | |
| DMSO (dimethylsulfoxide) | | | 1.30 |
| MDI 200 cps (diphenylmethane | 68.1 | 68.1 | 68.1 |
| diisocyanate) | | | |
| INDEX, percent | 2.20 | 2.20 | 2.20 |
| Surface friability top | Yes | no | no |
| Paper peeling after 10 minutes | complete | partial | partial |

### EXAMPLE 3

Using the procedures described in Example 1, a series of form cores were formed from a completely water-borne polyurethane (PUR) formulation (Foam Composition 1) and water blown PUR formulations incorporating different aprotic solvents (Foam Compositions 2-15) as described in Table 3. The foam core prepared from the completely water blown PUR formulation (Foam Composition 1) showed high surface friability. However, the foam cores prepared from the water blown PUR formulations utilizing different aprotic solvents (Foam Compositions 2-15) all showed a reduction in surface friability and some showed an even greater reduction in surface friability depending on the amount of solvent used in the foam composition (as in Foam Compositions 7 and 8).

TABLE 3

| | Foam Composition | | | | | | | |
|---|---|---|---|---|---|---|---|---|
| | 1 | 2 | 3 | 4 | 5 | 6 | 7 | 8 |
| | Solvent | | | | | | | |
| | No | Dimethly- | Dimethly- | propylene | propylene | Diethyl- | Diethyl- | Diethyl- |
| | Solvent | carbonate | carbonate | carbonate | carbonate | carbonate | carbonate | carbonate |
| Glendion RS 0700 (a polyol | 100 | 100 | 100 | 100 | 100 | 100 | 100 | 100 |
| available from Enichem), parts by | | | | | | | | |
| weight | | | | | | | | |
| Water, parts by weight | 6 | 6 | 6 | 6 | 6 | 6 | 6 | 6 |
| DMCHA (N,N- | 2 | 2 | 2 | 2 | 2 | 2 | 2 | 2 |
| dimethylcyclohexylamine), parts by | | | | | | | | |
| weight | | | | | | | | |
| Solvent amount, parts by weight | | 10 | 5 | 10 | 5 | 10 | 5 | 4 |
| Niax ® Silicone L-6900 (available | 1 | 1 | 1 | 1 | 1 | 1 | 1 | 1 |
| from GE Silicones), parts by weight | | | | | | | | |
| Suprasec 2085 (available from | 206 | 206 | 206 | 206 | 206 | 206 | 206 | 206 |
| Huntsman, LLC), parts by weight | | | | | | | | |
| Friability surface 1 = no; 5 = high | 5 | 1 | 1 | 2 | 2 | 2 | 2 | 3 |

| | Foam Composition | | | | | | |
|---|---|---|---|---|---|---|---|
| | 9 | 10 | 11 | 12 | 13 | 14 | 15 |
| | Solvent | | | | | | |
| | | | | | | Methyl- | ethylene- |
| | acetonitrile | DMSO | DMSO | Caprolactam | TEP | pyrrolidone | carbonate |
| Glendion RS 0700 (a polyol | 100 | 100 | 100 | 100 | 100 | 100 | 100 |
| available from Enichem), parts by | | | | | | | |
| weight | | | | | | | |
| Water, parts by weight | 6 | 6 | 6 | 6 | 6 | 6 | 6 |
| DMCHA (N,N- | 2 | 2 | 2 | 2 | 2 | 2 | 2 |
| dimethylcyclohexylamine), parts by | | | | | | | |
| weight | | | | | | | |
| Solvent amount, parts by weight | 5 | 10 | 5 | 5 | 5 | 5 | 3 |
| Niax ® Silicone L-6900 (available | 1 | 1 | 1 | 1 | 1 | 1 | 1 |
| from GE Silicones), parts by weight | | | | | | | |
| Suprasec 2085 (available from | 206 | 206 | 206 | 206 | 206 | 206 | 206 |
| Huntsman, LLC), parts by weight | | | | | | | |
| Friability surface 1 = no; 5 = high | 2 | 3 | 3 | 3 | 2 | 3 | 1 |

### EXAMPLE 4

Using the same procedures described in Example 2, a series of foam cores were prepared comprising a water and pentane blown PIR formulation (Foam Composition 16) and a water and pentane blown PIR formulations (NCO index 250) including an aprotic solvent (Foam Compositions 17-26) as described in table 4. The panel formed using the Foam Composition 16 showed severe wrinkling of the surface of the panel and high surface friabilty. Whereas, the Foam Composition 17-26 including the aprotic solvents showed a reduction in friability and in the formation of wrinkles on the surface of the panels made with these formulations and flexible facings, e.g., aluminum foil paper having a thickness of about 50 microns.

TABLE 4

| | Foam Composition | | | | | | | | | | |
|---|---|---|---|---|---|---|---|---|---|---|---|
| | 16 | 17 | 18 | 19 | 20 | 21 | 22 | 23 | 24 | 25 | 26 |
| | Solvent | | | | | | | | | | |
| | No | propylene | propylene | | | N-methyl- | N-methyl- | Dimethly- | Dimethly- | Solvent | Solvent |
| | Solvent | carbonate | carbonate | DMSO | DMSO | pirrolydone | pirrolydone | formamide | formamide | DBE ® | DBE ® |
| Stepanpol PS 3152 | 45 56.9 | 56.9 | 56.9 | 56.9 | 56.9 | 56.9 | 56.9 | 56.9 | 56.9 | 56.9 | 56.9 |
| (a polyol available from | | | | | | | | | | | |
| Stepan Corporation), | | | | | | | | | | | |
| parts by weight | | | | | | | | | | | |
| Water, parts by weight | 0.5 | 0.5 | 0.5 | 0.5 | 0.5 | 0.5 | 0.5 | 0.5 | 0.5 | 0.5 | 0.5 |
| Niax ® Catalyst | 2.0 | 2.0 | 2.0 | 2.0 | 2.0 | 2.0 | 2.0 | 2.0 | 2.0 | 2.0 | 2.0 |
| Potassium Octoate, | | | | | | | | | | | |
| parts by weight | | | | | | | | | | | |
| DMCHA (N,N- | 0.16 | 0.16 | 0.16 | 0.16 | 0.16 | 0.16 | 0.16 | 0.16 | 0.16 | 0.16 | 0.16 |
| dimethylcyclohexyl- | | | | | | | | | | | |
| amine), parts by weight | | | | | | | | | | | |
| Niax ® Silicone L-6912 | 1.0 | 1.0 | 1.0 | 1.0 | 1.0 | 1.0 | 1.0 | 1.0 | 1.0 | 1.0 | 1.0 |
| (available from GE | | | | | | | | | | | |
| Silicones), parts by | | | | | | | | | | | |
| weight | | | | | | | | | | | |
| TCPP (tris(2- | 6.2 | 6.2 | 6.2 | 6.2 | 6.2 | 6.2 | 6.2 | 6.2 | 6.2 | 6.2 | 6.2 |
| chloropropyl phosphate), | | | | | | | | | | | |
| parts by weight | | | | | | | | | | | |
| n-Pentane, | 13.0 | 13.0 | 13.0 | 13.0 | 13.0 | 13.0 | 13.0 | 13.0 | 13.0 | 13.0 | 13.0 |
| parts by weight | | | | | | | | | | | |
| Solvent, parts by weight | | 3.0 | 7.0 | 3.0 | 7.0 | 3.0 | 7.0 | 3.0 | 7.0 | 3.0 | 7.0 |
| Suprasec 2085 (available | 133.8 | 133.8 | 133.8 | 133.8 | 133.8 | 133.8 | 133.8 | 133.8 | 133.8 | 133.8 | 133.8 |
| from Huntsman, LLC), | | | | | | | | | | | |
| parts by weight | | | | | | | | | | | |

Reactivity

| | | | | | | | | | | | |
|---|---|---|---|---|---|---|---|---|---|---|---|
| CT, s | 25.0 | 27.0 | 29.0 | 23.0 | 17.0 | 24.0 | 21.0 | 22.0 | 23.0 | 27.0 | 30.0 |
| GT, s | 65.0 | 72.0 | 67.0 | 53.0 | 42.0 | 48.0 | 47.0 | 54.0 | 46.0 | 64.0 | 70.0 |
| TFT, s | 180.0 | 190.0 | 162.0 | 290.0 | 126.0 | 180.0 | 157.0 | 182.0 | 139.0 | 180.0 | 240.0 |

Foam poured in plastic bag and cured at room temperature

| | | | | | | | | | | | |
|---|---|---|---|---|---|---|---|---|---|---|---|
| Surface wrinkling: | 5 | 3 | 3 | 1 | 0.5 | 1 | 1 | 1 | 1 | 3 | 3 |
| 5 = severe, 1 = smooth | | | | | | | | | | | |
| Friability: | 5 | 5 | 5 | 2 | 2 | 3 | 2 | 2 | 0 | 5 | 0 |
| 5 = severe, 1 = none | | | | | | | | | | | |

Foam poured on 50 micron aluminum foil in a mold heated at 45° C. and cured for 3 minutes in the mold

| | | | | | | | | | | | |
|---|---|---|---|---|---|---|---|---|---|---|---|
| Panel density | 35.0 | 34.4 | 35.7 | 34.2 | 34.3 | 35.4 | 36.2 | 35.4 | 37.0 | 35.3 | 36.3 |
| Surface wrinkling: | 5.0 | 3.0 | 2.0 | 2.0 | 2.0 | 2.0 | 1.0 | 2.0 | 2.0 | 3.0 | 2.0 |
| 5 = severe, 1 = smooth | | | | | | | | | | | |

Dimensional stability

| | | | | | | | | | | | |
|---|---|---|---|---|---|---|---|---|---|---|---|
| percent Vol. Chg: | −2.19 | 0.31 | −0.58 | 0.06 | −0.30 | −0.83 | −0.59 | n.d. | n.d. | 0.47 | −0.34 |
| 1 days −25° C. | | | | | | | | | | | |
| percent Vol. Chg: | 3.04 | 2.33 | 0.93 | 1.81 | 0.77 | 2.25 | 1.44 | n.d. | n.d. | 2.04 | 3.22 |
| 1 days +70° C. | | | | | | | | | | | |
| 90 percent RH | | | | | | | | | | | |

While exemplary embodiments have been shown and described, it will be understood by those skilled in the art that various modifications and substitutions may be made thereto without departing from the spirit and scope of the invention. Accordingly, it is to be understood that the present invention has been described by way of illustrations and not limitation.

What is claimed is:

1. Polyurethane or polyisocyanurate foam composition wherein at least 10 percent of the blowing gas volume is carbon dioxide formed from the reaction of polyisocyanate and water or organic acid and including a dipolar aprotic solvent in an amount from 1 percent by weight to 10 percent by weight based on the total weight of the foam-forming mixture.

2. The composition according to claim 1, wherein the polyisocyanate is selected from the group consisting of aromatic polyisocyanates, aliphatic polyisocyanates, araliphatic polyisocyanates and cycloaliphatic polyisocyanates and combinations thereof.

3. The composition according to claim 1, wherein the dipolar aprotic organic solvent is selected from the group consisting of dialkyl sulfoxide, N,N-dialkylalkanoamide, phosphonate, tetramethylenesulfone, 1-methyl-2-pyrrolidinone, trialkyl phosphate, acetonitrile, organic carbonate, and mixtures thereof.

4. The composition according to claim 3, wherein the dialkyl sulfoxide is dimethyl sulfoxide, diethyl sulfoxide or diisobutyl sulfoxide.

5. The composition according to claim 3, wherein the N,N-dialkylalkanoamide is N,N-dimethylformamide, N,N-dimethylacetamide or N,N-diethylacetamide.

6. The composition according to claim 3, wherein the phosphonate is O,O-dimethyl, O,O-diethyl, O,O-diisopropyl methylphosphonates or O,O-di(2-chloroethyl) vinylphosphonate.

7. The composition according to claim 3, wherein the trialkyl phosphate is trimethyl or triethyl phosphate.

8. The composition according to claim 3, wherein the organic carbonate is di-methyl-carbonate, ethylene-carbonate or propylene-carbonate.

9. The composition according to claim 1, wherein the polyurethane or polyisocyanurate foam-forming reaction mixture comprises polyisocyanate, polyol and a catalyst for the polyurethane or polyisocyanurate foam-forming reaction.

10. The composition according to claim 1, wherein at least 50 percent of the blowing gas volume is carbon dioxide formed from the reaction of polyisocynate and water or organic acid.

11. The composition according to claim 1, wherein at least 70 percent of the blowing gas volume is carbon dioxide formed from the reaction of polyisocynate and water or organic acid.

12. The composition according to claim 1, wherein the dipolar aprotic solvent is present therein in an amount of from 2 percent by weight to 8 percent by weight based on the total weight of the foam-forming mixture.

13. The composition according to claim 1, wherein the balance of the blowing gas volume, if any, is provided by a physical blowing agent.

14. The composition according to claim 1, wherein the blowing gas is carbon dioxide formed from the reaction of polyisocyanate and water or organic acid is not more than 70 percent of the total blowing gas volume.

15. The composition according to claim 10, wherein the polyurethane or polyisocyanurate foam-forming reaction mixture comprises a physical blowing agent which contributes no more than 50 percent of the total blowing gas volume.

16. The composition according to claim 11, wherein the polyurethane or polyisocyanurate foam-forming reaction mixture comprises a physical blowing agent which contributes no more than 30 percent of the total blowing gas volume.

17. The composition according to claim 13, wherein the physical blowing agent is selected from the group consisting of acetone, ethyl acetate, a halogenated alkane, butane, hexane, heptane, diethylether, a pentane, and mixtures thereof.

18. The composition according to claim 17, wherein the halogenated alkane is selected from the group consisting of methylene chloride, chloroform, ethylidene chloride, vinylidene chloride, monofluorotrichloromethane, chlorodifluoromethane, dichlorodifluoromethane, trichlorotrifluoroethane, a hydrochlorofluorocarbon compound, a hydrofluoro carbon compound, and mixtures thereof.

19. The composition according to claim 1, wherein the polyisocyanate is a methylene bis(phenylisocyanate).

20. The composition according to claim 1, wherein at least 30 percent of the blowing gas volume is carbon dioxide formed from the reaction of polyisocynate and water or organic acid.
